(19) United States
(12) Patent Application Publication
(10) Pub. No.: US 2015/0113283 A1
(43) Pub. Date: Apr. 23, 2015

(54) PROTECTING CREDENTIALS AGAINST PHYSICAL CAPTURE OF A COMPUTING DEVICE

(71) Applicants: Francisco Corella, Carmichael, CA (US); Karen Pomian Lewison, Carmichael, CA (US)

(72) Inventors: Francisco Corella, Carmichael, CA (US); Karen Pomian Lewison, Carmichael, CA (US)

(73) Assignee: POMIAN & CORELLA, Carmichael, CA (US)

(21) Appl. No.: 14/588,413

(22) Filed: Jan. 1, 2015

Related U.S. Application Data
(63) Continuation-in-part of application No. 14/016,022, filed on Aug. 30, 2013.
Application No. 14/016,022 is a continuation-in-part of application No. 13/954,973, filed on Jul. 30, 2013.
Application No. 13/954,973 is a continuation-in-part of application No. 13/925,824, filed on Jun. 24, 2013.
(60) Provisional application No. 61/936,860, filed on Feb. 6, 2014.
(60) Provisional application No. 61/936,864, filed on Feb. 6, 2014.
(60) Provisional application No. 61/695,293, filed on Aug. 30, 2012.
(60) Provisional application No. 61/663,569, filed on Jun. 23, 2012.
(60) Provisional application No. 61/677,011, filed on Jul. 30, 2012.
(60) Provisional application No. 61/804,638, filed on Mar. 23, 2013.
(60) Provisional application No. 61/809,790, filed on Apr. 8, 2013.

(51) Int. Cl. G06F 21/31; H04L 9/32

(52) U.S. Cl. CPC G06F 21/31; H04L 9/3236; H04L 9/3247
USPC 713/185

(57) ABSTRACT

A method of activating credentials that are stored encrypted while inactive. In one embodiment a decryption key is retrieved from a key storage service after the device authenticates to the service by sending a passcode and/or a biometric key, a public key and a signature computed with a private key, the service verifying the signature and comparing a hash of the public key and the passcode and/or biometric key to a reference hash.

### CROSS-REFERENCE TO RELATED APPLICATIONS

This application claims priority to U.S. Provisional Patent Application Ser. No. 61/936,860, filed on Feb. 6, 2014, U.S. Provisional Patent Application Ser. No. 61/936,864, filed on Feb. 6, 2014, and U.S. Provisional Patent Application Ser. No. 61/947,401, filed on Mar. 3, 2014, and is a continuation in part of U.S. Non-Provisional patent application Ser. No. 14/016,022, filed on Aug. 30, 2013, which claims priority to U.S. Provisional Patent Application Ser. No. 61/695,293, filed on Aug. 30, 2012, and is a continuation in part of U.S. Non-Provisional patent application Ser. No. 13/954,973, filed on Jul. 30, 2013, which is a continuation-in-part of U.S. Non-Provisional patent application Ser. No. 13/925,824, filed Jun. 24, 2013, which claims priority to U.S. Provisional Application Ser. No. 61/663,569, filed on Jun. 23, 2012, U.S. Provisional Application Ser. No. 61/677,011, filed on Jul. 30, 2012, U.S. Provisional Application Ser. No. 61/804,638, filed on Mar. 23, 2013, and U.S. Provisional Application Ser. No. 61/809,790, filed on Apr. 8, 2013, all of which applications are incorporated herein by reference.

### BACKGROUND

Credentials of various kinds can be stored in a general purpose computing device and used for many purposes, such as authenticating to an online service, signing outgoing email messages and decrypting incoming email messages, obtaining physical access to a facility by authenticating to a Near Field Communication (NFC) reader at the entrance to the facility, making online payments on the Web, or making in-store payments by tapping the computing device on an NFC point-of-sale terminal. An important type of credential that can be stored in a computing device and used, among other purposes, for authentication, digital signature or email decryption, is a certified key pair, consisting of a private key and an associated public key that is included in a certificate and bound by the certificate to data such as a user identifier.

But computing devices, particularly mobile ones such as smart phones, tablets, or laptops, may be physically captured by an adversary. For example, more than 3 million smart phones were stolen in 2013 in the US alone, according to a report by Consumer Reports, available online at http://www.consumerreports.org/cro/news/2014/04/smart-phone-thefts-rose-to-3-1-million-last-year/index.htm. To prevent a thief who steals a computing device from using credentials stored in the device, a credential activation program running on the device can ask the user to enter an activation passcode, such as a personal identification number (PIN) or a password, and allow the credentials to be used only if the correct passcode is entered. But the thief may be able to read the credentials from the device storage and load them into a different device where their use is not subject to the activation program; or the thief may be able to modify the activation program on the stolen device so that it does not require entry of the correct passcode.

Therefore it is necessary to protect credentials stored in a computing device from physical capture of the device by an unauthorized user.

Credentials can be protected by storing them in a secure element that provides physical tamper resistance. But even if a secure element is present in the device, the system architecture of the device often makes it difficult or impossible for applications running on the device to use it. Credentials can also be stored in physically tamper resistant storage within an ancillary device connected to the computed device, such as a dongle plugged into a USB port of the computing device, or a smart card inserted into a card reader built into the device or connected to the device. But having to use an ancillary device for storing credentials is often deemed inconvenient to the user, and having to procure ancillary devices and distribute them to users is often deemed costly and cumbersome. Furthermore, physical tamper resistance may not provide complete protection, as shown by a presentation at the Black Hat conference in 2010, available online at http://www.securitytube.net/video/945, in which a security researcher demonstrated how he was able to reverse engineer and defeat the tamper resistance features of a family of chips used as secure elements.

For the specific purpose of user authentication, it is possible to use both a passcode such as a password or an easy-to-enter PIN supplied by the user, and a cryptographic credential stored in the computing device, such as a key pair pertaining to a digital signature cryptosystem. The passcode and a signature computed with the public key component of the key pair are sent to the party that requires user authentication, which verifies the signature using the public key component of the key pair, and checks that a hash of the passcode matches a salted hash stored in a database. But an attacker who breaches the security of the database can use the salted hashes in the database to mount a dictionary attack against each passcode and recover all but the highest entropy passcodes. If the attacker then physically captures a computing device whose passcode has been recovered, the attacker can use the device to authenticate without having to read any credential from the device storage or modify a credential activation program.

Instead of using together a passcode and a certified key pair by submitting the password and a signature to a verifier, it is possible to encrypt a data structure comprising the certified key pair, or at least its private key component, under a key derived from the passcode. When the user supplies the passcode, the data structure is decrypted and a signature computed with the private key component of the key pair is sent to the verifier. The passcode is not sent, and a hash of the passcode is not stored in a verifier database; hence an adversary cannot mount an offline attack against a collection of passcodes after breaching database security. But an attacker who captures the computing device can mount an offline attack against the passcode supplied by the user of that device, testing each guess of the passcode by decrypting the data structure and checking if the result of the decryption is a well formed data structure comprising a private key that corresponds to the public key contained in the certificate, which may be found in the decrypted data structure, or may be stored in the clear within the device, or may be available in a directory.

For protection against such an offline attack, in U.S. patent application Ser. No. 08/996,758, filed on Dec. 23, 1997 and now patented as U.S. Pat. No. 6,170,058, Kausik discusses a technique called “cryptographic camouflaging”. However, Kausik describes several attacks that can be made against cryptographic camouflaging. The patent discusses means of resisting those attacks, but some of those means are impractical. One of those means requires the use of certificates in which the certified public key is encrypted in such a way that it can only be decrypted by a particular verifier, i.e. by a particular party that relies on the certificate; this is impractical because it requires the certificate authority to issue and sign multiple certificates for a public key, one for each relying party. Another one of those means requires the use of “strongly random bits” (i.e. truly random bits rather than pseudo-random bits or bits generated by an entropy accumulator) in the construction of a signature; this is impractical because not enough entropy may be available to generate enough true random bits in the course of a transaction. U.S. patent application Ser. No. 09/750,511 filed by Kausik on Dec. 27, 2000 and now patented as U.S. Pat. No. 6,956,950, U.S. patent application Ser. No. 09/874,795 filed by Hird on Jun. 6, 2001 and now patented as U.S. Pat. No. 7,328,350, and U.S. patent application Ser. No. 10/015,902 filed by Rajasekaran et al. on Oct. 30, 2001 and now patented as U.S. Pat. No. 7,454,782, discuss similar camouflaging techniques that have similar drawbacks.

Instead of encrypting a certified key pair under a key derived from a password, it is possible to encrypt one or more user credentials, usable for any purpose, under a random or pseudo-random credential encryption key that is entrusted to a remote server for secure storage. When the user activates the user credentials before using them, the credential encryption key is retrieved from the server and used to decrypt the user credentials. However, retrieving the credential encryption key requires authenticating to the server, to prevent an attacker from retrieving the credential encryption key and using it to decrypt the user credentials after capturing the computing device; and authenticating to the server requires one or more ad-hoc credentials, which must themselves be protected against an adversary who captures the device.

In U.S. patent application Ser. No. 14/194,703, filed on Mar. 1, 2014, Bokarius et al. discuss using as ad-hoc credentials a PIN and a key pair, the private key component of the key pair being used to compute a signature that is sent along with the PIN to the server. But this has the drawbacks mentioned above when considering the use of a passcode and a key pair for authentication. (U.S. patent application Sere. No. 14/194,703 is further discussed below in the Detailed Description section of the present application.)

In U.S. patent application Ser. No. 10/093,881, filed on Mar. 8, 2002 and now patented as U.S. Pat. No. 7,711,122, Allen et al. discuss using as ad-hoc credentials a certified key pair, which may be stored in the computing device protected with cryptographic camouflaging, or in a smart card. But this has the above-mentioned drawbacks associated with cryptographic camouflaging or with the use of a smart card for credential storage. Furthermore, Allen et al. protect the credential key in transit, as it is sent from the server to the computing device, by encrypting it with a public key component of a one-time key pair; but generating a one-time key pair is a computationally expensive operation, and performing it each time the credential encryption key must be retrieved may be too costly in terms of latency and energy consumption if the computing device is a mobile phone with a slow processor and a limited capacity battery.

Therefore there is a need for further means of protecting credentials stored in a computing device against being used by an unauthorized user who physically captures the device.

### SUMMARY

In one embodiment credentials stored in a computing device are encrypted while inactive. To activate the credentials, a user enters a passcode and/or a biometric sample from which a biometric key is derived. A decryption key is then retrieved from a key storage service after the device authenticates to the service by sending the passcode and/or the biometric key, a public key and a signature computed with a private key, the service verifying the signature and comparing a hash of the public key and the passcode and/or biometric key to a reference hash.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. Reference numerals consist of a concatenation of a one- or two-digit number referring to a figure, followed by a two-digit number that locates the referenced part within the figure. A reference numeral introduced in a figure may be used in other figures to refer to the same part or a similar part.

FIG. 1 is a block diagram illustrating a system for protecting credentials stored in a computing device against being used by an unauthorized user, by storing a credential activation key in a key storage service hosted on a remote server.

FIG. 2 is a block diagram illustrating a system for protecting credentials using a key storage service located in a ancillary device.

FIG. 3 is a block diagram illustrating a system for protecting credentials using a key storage service located in a secure element.

FIG. 4 is a flow diagram of a process for activating functional credentials by decrypting them.

FIG. 5 is a dataflow diagram of the derivation of an activation credential that comprises a stored key pair and passcode.

FIG. 6 is a dataflow diagram of the derivation of an activation credential that comprises a key pair regenerated from a protocredential and a passcode.

FIG. 7 is a dataflow diagram of the derivation of an activation credential that comprises a stored key pair and a biometric key.

FIG. 8 is a dataflow diagram of the derivation of an activation credential that comprises a key pair regenerated from a protocredential and a biometric key.

FIG. 9 is a dataflow diagram of the derivation of an activation credential that comprises a stored key pair, a passcode and a biometric key.

FIG. 10 is a dataflow diagram of the derivation of an activation credential that comprises a key pair regenerated from a protocredential, a passcode and a biometric key.

FIG. 11 is a flow diagram of a process for regenerating a DSA key pair.

FIG. 12 is a block diagram of a device record comprising a hash of a public key as a reference parameter.

FIG. 13 is a block diagram of a device record comprising a hash of a public key and one or more bearer tokens as reference parameters.

FIG. 14 is a block diagram of a device record comprising a hash of a public key and password as reference parameters.

FIG. 15 is a block diagram of a device record comprising a hash of a public key and a biometric key as reference parameters.

FIG. 16 is a block diagram of a device record comprising a hash of a public key, a password and a biometric key as reference parameters.

FIG. 17 is a flow diagram of a process for retrieving a credential activation key over a secure connection after authenticating with a digital signature.

FIG. 18 is a flow diagram of a process for retrieving a credential activation key over a secure connection after authenticating with a digital signature and one or more bearer tokens.

FIG. 19 is a flow diagram of a process for retrieving a credential activation key encrypted under an ephemeral key after authenticating with a digital signature.

FIG. 20 is a flow diagram of a process for retrieving a credential activation key encrypted under an ephemeral key after authenticating with a digital signature and bearer tokens.

FIG. 21 is a block diagram illustrating user authentication and email credentials similar to credentials carried in a PIV card, encrypted while inactive for protection against physical capture.

FIG. 22 is a block diagram illustrating payment credentials encrypted while inactive for protection against physical capture.

### DETAILED DESCRIPTION

This Detailed Description refers to the accompanying drawings, which are a part hereof and illustrate examples of embodiments of the invention. It is to be understood that other embodiments are possible, and that the features of different exemplary embodiments can be combined together unless otherwise stated.

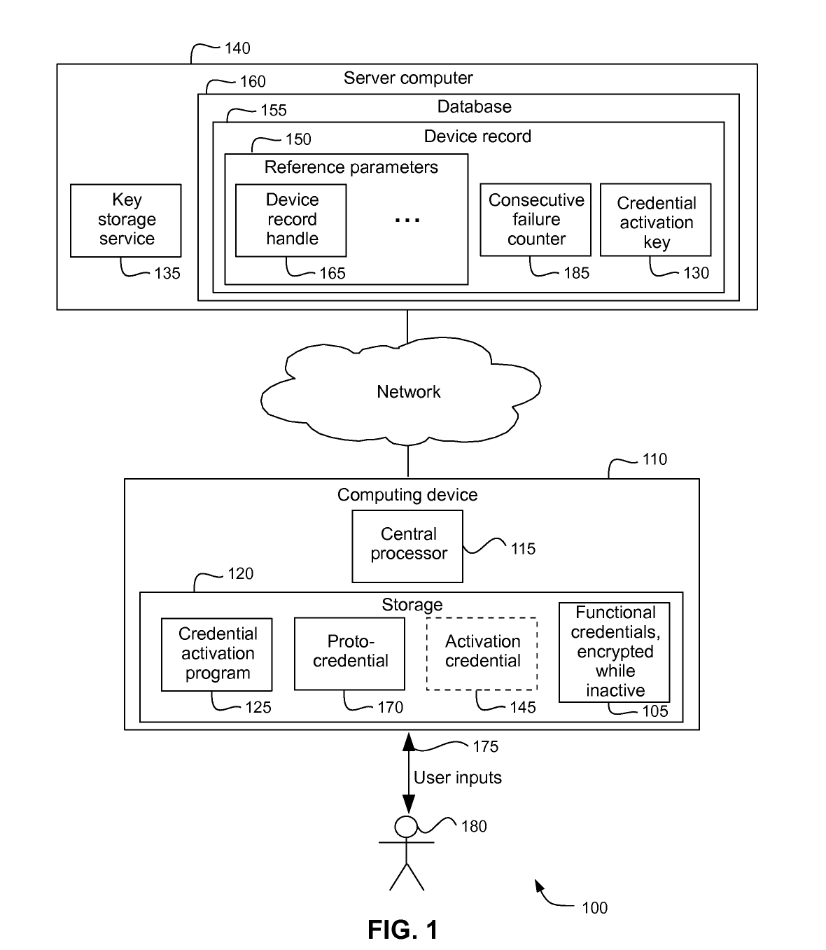

FIG. 1 is a block diagram illustrating a system 100 for protecting one or more credentials 105 stored in a computing device 110 against being used by an unauthorized user who physically captures the device, according to some embodiments. The computing device 110 comprises a central processor 115, a storage 120 wherein the credentials 105 are stored, and a credential activation program 125, also stored in storage 120, which is executed by processor 115 to activate the credentials. While inactive, the credentials are stored in encrypted form. Before they can be used, they must be activated. Program 125 activates the credentials 105 by decrypting them with one or more decryption keys derived from a credential activation key 130.

In some embodiments the credential activation key itself is used as the decryption key for all the functional credentials. (The concept of “derivation” is to be understood herein as including the application of an identity function that does not modify its input.) In other embodiments the HMAC-based Extract-and-Expand Key Derivation Function (HKDF), described in Request For Comments (RFC) 5869 of the Internet Engineering Task Force (IETF), is used to derive different decryption keys for different functional credentials, using the credential activation key as the Salt input, and using different Input Keying Material (IKM) inputs to derive different decryption keys. One reason to use different decryption keys is to let some of them be derived from additional keys besides credential activation key 130, different additional keys being present at different times in the device.

The credential activation key 130 is a random high-entropy bit string created in the course of a setup process by a key storage service 135 hosted on a remote server computer 140. At credential activation time, activation program 125 retrieves key 130 from service 135 by means of a two-party key-retrieval protocol in the course of which program 125 authenticates to service 135 by proving possession of an activation credential 145, distinct from the above-mentioned credentials 105; to easily distinguish credentials 105 from activation credential 145, the former will henceforth referred to as functional credentials. Service 135 verifies the proof of possession of activation credential 145 using reference parameters 150 stored together with credential activation key 130 in a device record 155 corresponding to computing device 110 and stored among other device records corresponding to other devices in a database 160 stored in server 140. Device record 155 contains a device record handle 165 that uniquely identifies the record among other device records in database 160 and is one of reference parameters 150. (The term “handle” is used instead of the term “primary key” more commonly used in the database art to avoid confusion with a cryptographic key.) In some embodiments the device record handle is generated by the key storage service or by a database management system that manages database 160, and sent by the key storage service to the computing device, which stores it in storage 120, while in other embodiments it is generated by the computing device as a random high entropy string unlikely to conflict with other database handles, stored in storage 120, and sent by the device to the service, communication between the device and the service at setup time taking place with confidentiality protection and mutual authentication, the device authenticating to the service using a setup security code obtained out of band.

Service 135 maintains a counter 185 of consecutive authentication failures in device record 155. The counter is incremented each time service 135 receives an authentication request with an invalid credential that specifies device record handle 165, and reset to zero each time the service receives a valid authentication request that specifies such handle. When the value of the counter reaches a configured limit the service locks out the computing device 110 by deeming the device record invalid once the value has reached the limit, and eventually deleting the record.

Each functional credential is provisioned to the computing device by a provisioning process that imports the credential into the computing device and encrypts it by means of a symmetric cipher such as AES in a mode such as cipher feedback (CFB) or output feedback (OFB), using a random initialization vector and a symmetric encryption key which will later be used as the decryption key for the credential. The symmetric key is derived from the credential activation key, which is retrieved to that purpose by the activation program from the key storage service, with confidentiality protection and mutual authentication, using the activation credential for authentication of the computing device to the service. The provisioning process stores the encrypted functional credential in storage 120 together with the initialization vector.

Activation credential 145 is illustrated in FIG. 1 by a box drawn with dashed lines because it is not permanently stored in storage 120 together with the functional credentials. Instead, it is derived at activation time by activation program 125 from a protocredential 170 stored in storage 120 and one or more user inputs 175 from a user 180. The term “protocredential” is herein defined as a collection of one or more permanently stored parameters that can be used to derive a credential in combination with one or more parameters that are not permanently stored. One of the protocredential parameters is the device record handle 165, generated by the computing device or retrieved by the key storage service at setup time as explained above.

In some embodiments, henceforth called “embodiments of type I”, activation credential 145 consists of device record handle 165, a passcode and an uncertified key pair. (The term “key pair” is used herein to refer to a collection of parameters of a public key cryptosystem used for purposes such as digital signature and signature verification, encryption and decryption, or key agreement, one or more parameters comprising a private key while one or more other parameters comprise a public key. An “uncertified key pair” is a key pair whose public key component has not been certified by a certificate authority, and therefore is not included in a certificate signed by certificate authority.) The passcode is a user input while the uncertified key pair is a protocredential parameter.

In other embodiments, henceforth called “embodiments of type II”, it consists of the device record handle, and an uncertified key pair that is regenerated from the protocredential parameters and a passcode (after being initially generated at setup time), the passcode being a user input.

In other embodiments, henceforth called “embodiments of type III”, it consists of the device record handle, a biometric key, and an uncertified key pair, the biometric key being regenerated from a biometric sample and helper data. (The term “biometric key” is used herein to refer to a parameter that is consistently regenerated from helper data and varying but genuine biometric samples. Several biometric key generation methods have been described in the biometric literature. One method is described in the Technical Report Number 640 of the Computer Laboratory of the University of Cambridge, entitled “Combining cryptography with biometrics effectively”, by Feng Hao, Ross Anderson and John Daugman, dated July 2005. References to other biometric key generation methods can be found in the survey article entitled “Biometric Template Security”, by Anil K. Jain, Karthik Nandakumar and Abhishek Nagar, published in the EURASIP Journal on Advances in Signal Processing, volume 2008. Additional references can be found in the survey article entitled “A Survey on Biometric Cryptosystems and Cancelable Biometrics”, by C. Rathgeb and A. Uhl, published in the EURASIP Journal on Advances in Signal Processing, volume 2011.) The biometric sample is a user input while the key pair is a protocredential parameter. The helper data is created at setup time from a reference biometric sample supplied by the user and stored in storage 120 as a protocredential parameter; however, even though the helper data is derived from the reference biometric sample, it is deemed infeasible to extract any biometric information from the helper data.

In other embodiments, henceforth called “embodiments of type IV”, it consists of the device record handle and an uncertified key pair that is regenerated from the protocredential parameters and a biometric sample, the biometric sample being a user input, a biometric key being an intermediate result in the computation that regenerates the protocredential.

In other embodiments, henceforth called “embodiments of type V”, it consists of the device record handle, a passcode, a biometric key, and an uncertified key pair, the passcode being a user input, the biometric key being regenerated from a biometric sample which is a user input and helper data which is a protocredential parameter, the key pair being a protocredential parameter.

In other embodiments, henceforth called “embodiments of type VI”, it consists of the device record handle and an uncertified key pair that is regenerated from the protocredential parameters, a passcode and a biometric sample, the passcode being a user input, the biometric key being regenerated from a biometric sample which is a user input and helper data which is a protocredential parameter.

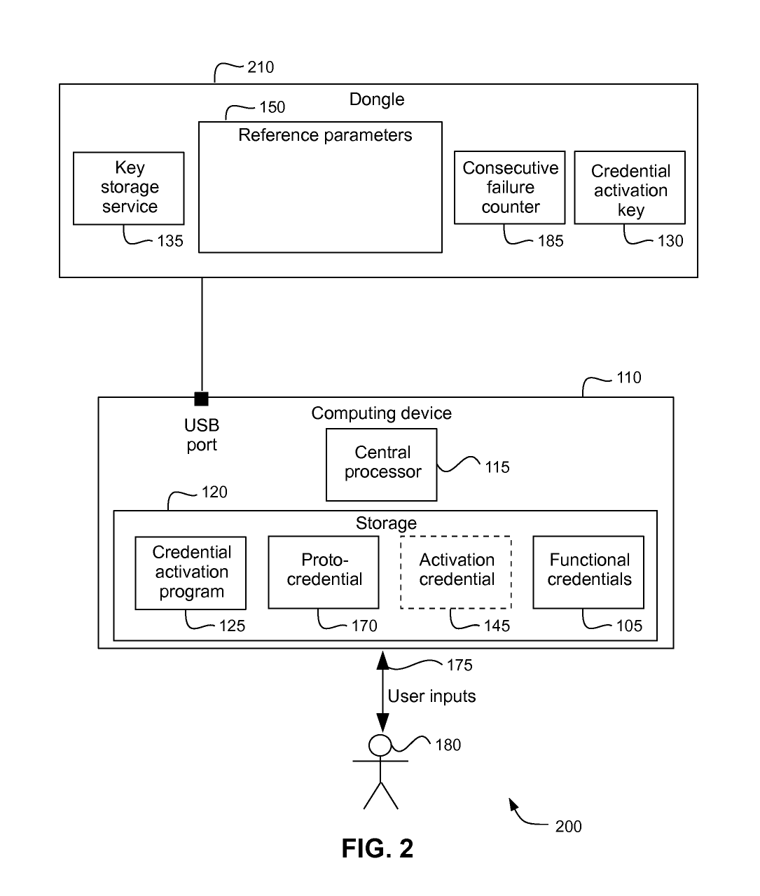

FIG. 2 is a block diagram illustrating a system 200 for protecting one or more credentials 105 stored in a computing device 110 against being used by an unauthorized user who physically captures the device, according to embodiments alternative to those illustrated by FIG. 1. System 200 differs from system 100 of FIG. 1 in that key storage service 135, reference parameters 150, consecutive failure counter 185 and credential activation key 130 are located in an ancillary device 210 directly connected to the computing device 110, such as a dongle plugged into a USB port of the computing device. In some embodiments the ancillary device is configured to be used with only one device; in such embodiments there is no need for a database of device records, and the reference parameters do not include a device record handle.

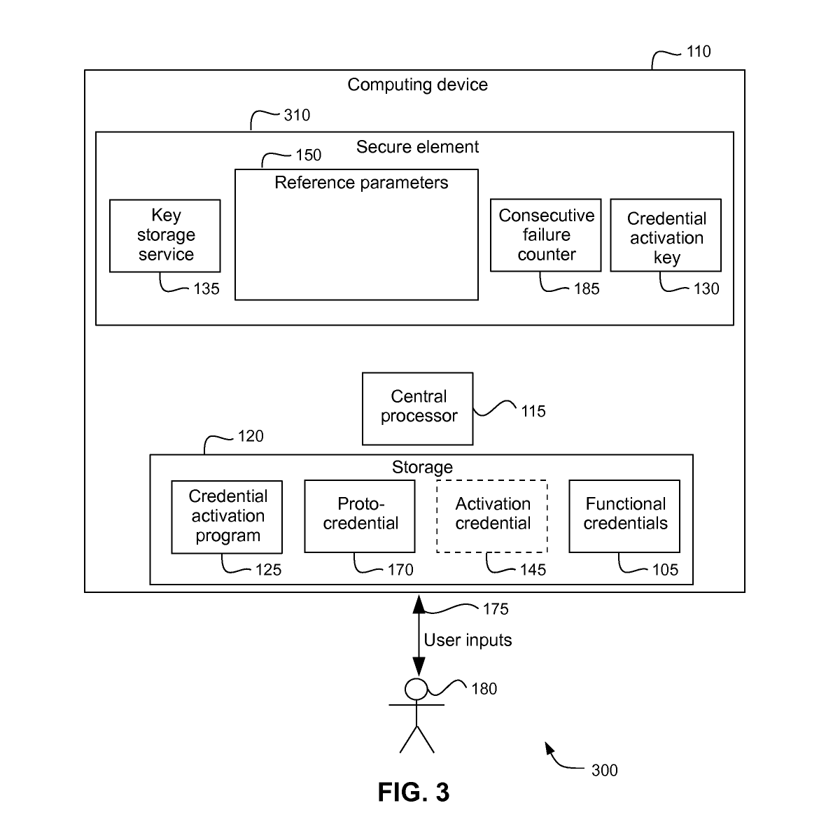

FIG. 3 is a block diagram illustrating a system 300 for protecting one or more credentials 105 stored in a computing device 110 against being used by an unauthorized user who physically captures the device, according to embodiments alternative to those illustrated by FIGS. 1-2. System 300 differs from systems 100 and 200 of FIGS. 1-2 in that key storage service 135, reference parameters 150, consecutive failure counter 185 and credential activation key 130 are located in a secure element 310 within the computing device 110, the secure element providing some degree of physical tamper resistance. In various embodiments the secure element may be a Universal Integrated Circuit Card (UICC), a chip embedded in the chipset of computing device 110, a component of a System on a Chip (SoC) that also includes the central processor 115, or a Secure Digital microSD memory card. Since the secure element is part of, or used with, a particular computing device, there is no need for a database of device records, and the reference parameters do not include a device record handle.

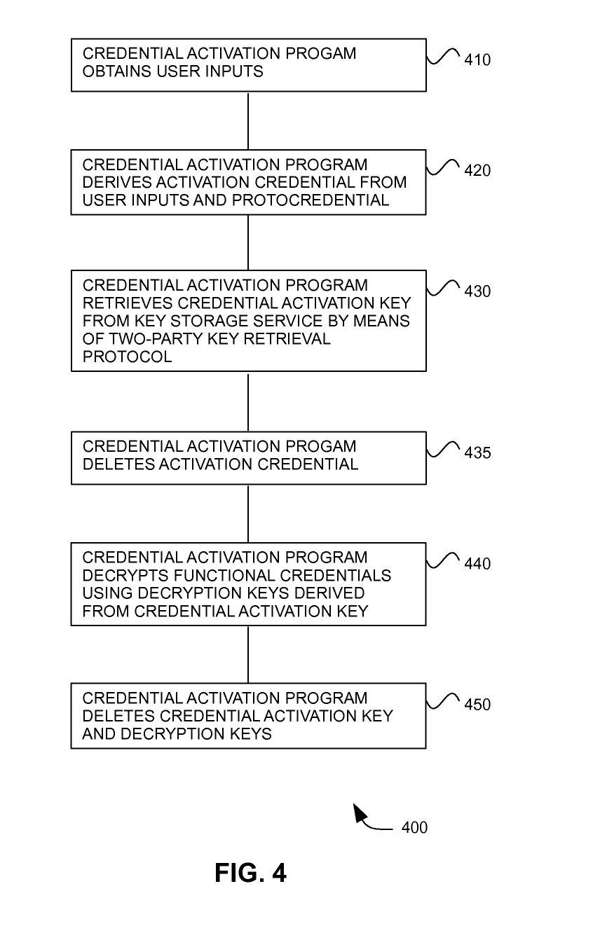

FIG. 4 is a flow diagram of a process 400 for activating functional credentials 105 stored in storage 120 of computing device 110, according to various embodiments.

At 410, credential activation program 125 obtains one or more user inputs 175 from user 180. Then the process continues at 420.

At 420, the credential activation program derives activation credential 145 from user inputs 175 and protocredential 170. Then the process continues at 430.

At 430, the credential activation program retrieves credential activation key 130 from key storage service 135 and stores it temporarily in storage 120. The credential activation key is retrieved by means of a two-party key-retrieval protocol wherein the program proves possession of the activation credential to the service using activation credential 145. Then the process continues at 435.

At 435 the credential activation program deletes the activation credential. Then the process continues at 440.

At 440 the credential activation program decrypts the functional credentials using one or more decryption keys derived from the credential activation key and initialization vectors stored together with the ciphertexts of the encrypted credentials. The resulting plaintexts are temporarily stored in storage 120, without removing the permanently stored ciphertexts and initialization vectors. After 440, the process continues at 450.

At 450 the credential activation program deletes the credential activation key and the decryption keys derived from it from storage 120, so that they cannot be found by an unauthorized user who captures the device and is able to tamper with it and read the contents of the storage. Step 450 takes place as soon as the decryption keys have been derived and the functional credentials have been decrypted. The activation process terminates after step 450.

The functional credentials are later deactivated, when no longer needed, by deleting their plaintexts from storage 120.

In some embodiments the credential activation key retrieved from the key storage service, the decrypion keys derived from the credential activation key and the plaintexts of the functional credentials are stored in a volatile portion of storage 120, so that they disappear without explicit deletion if power is lost by the computing device.

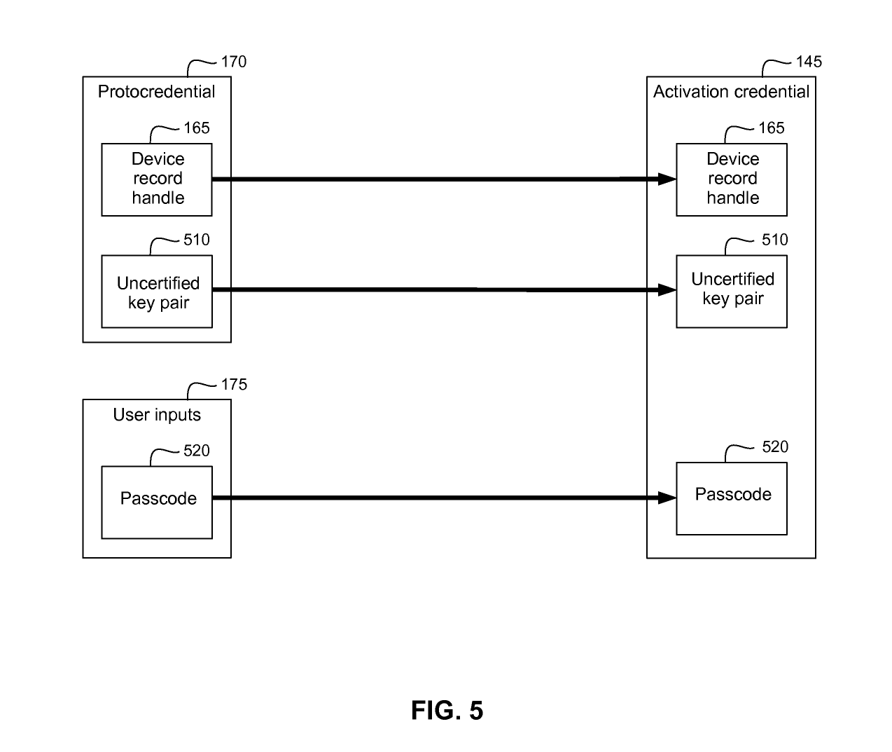

FIGS. 5-10 are dataflow diagrams of the derivation of activation credential 145 from protocredential 170 and user inputs 175 at step 420 of process 400, according to embodiments of types I-VI respectively.

According to some embodiments of type I illustrated in FIG. 5, activation credential 145 is trivially derived by bringing together its components without any computation, including device record handle 165 and uncertified key pair 510, which are protocredential parameters, and passcode 520, which is a user input.

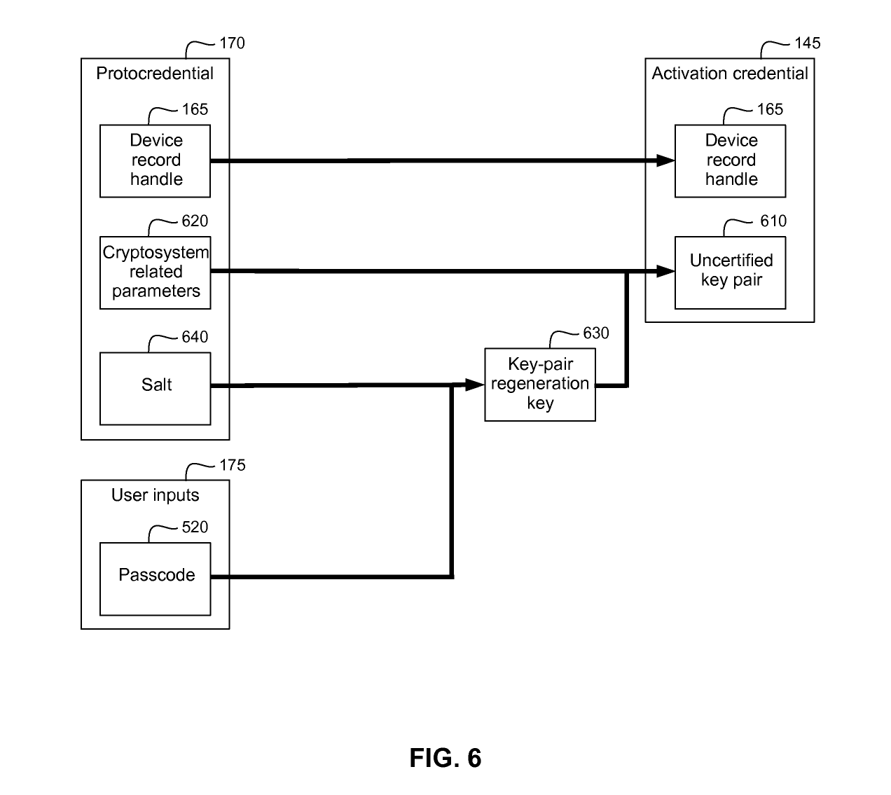

According to some embodiments of type II illustrated in FIG. 6, activation credential 145 comprises device record handle 165, which is a protocredential parameter, and uncertified key pair 610. The key pair is regenerated from cryptosystem related parameters 620 and a key-pair regeneration key 630, which is itself computed using HKDF with a random high-entropy salt 640 as Salt input, passcode 520 as Input Keying Material, and a value of the byte-length input parameter L that causes the output to be a string of bitlength suitable for the cryptosystem of key pair 610. Cryptosystem related parameters 620 and salt 640 are protocredential parameters, while passcode 520 is a user input.

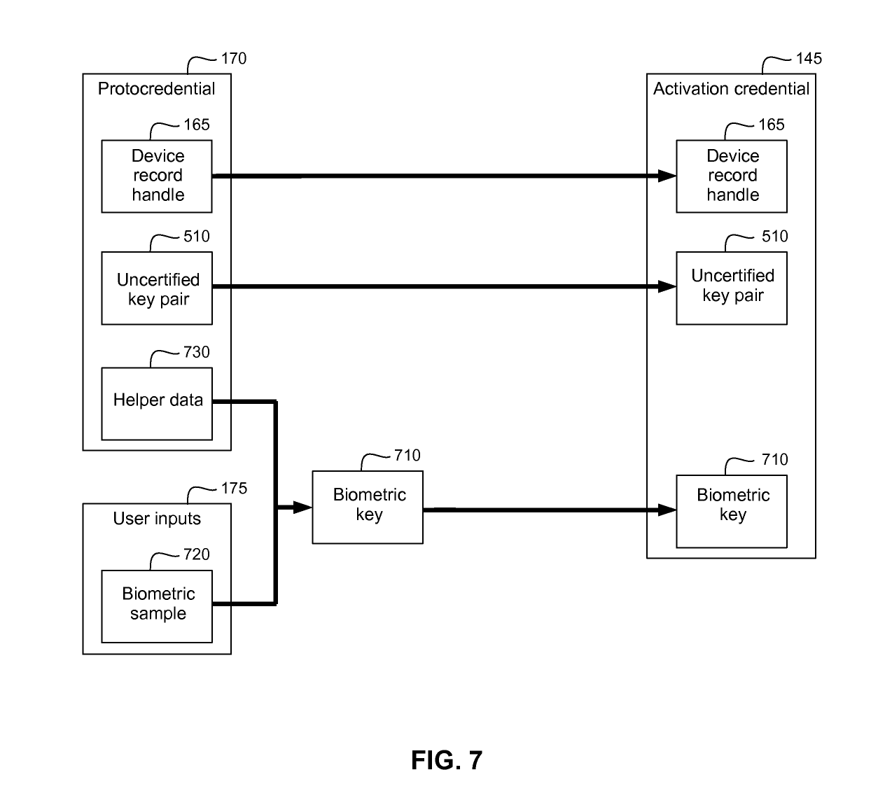

According to some embodiments of type III illustrated in FIG. 7, activation credential 145 comprises device record handle 165 and uncertified key pair 510, which are protocredential parameters, and biometric key 710, which is regenerated from biometric sample 720 and helper data 730 by one of the biometric key generation methods described in the above mentioned biometric literature. Biometric sample 720 is a user input, while helper data 730 is a protocredential parameter.

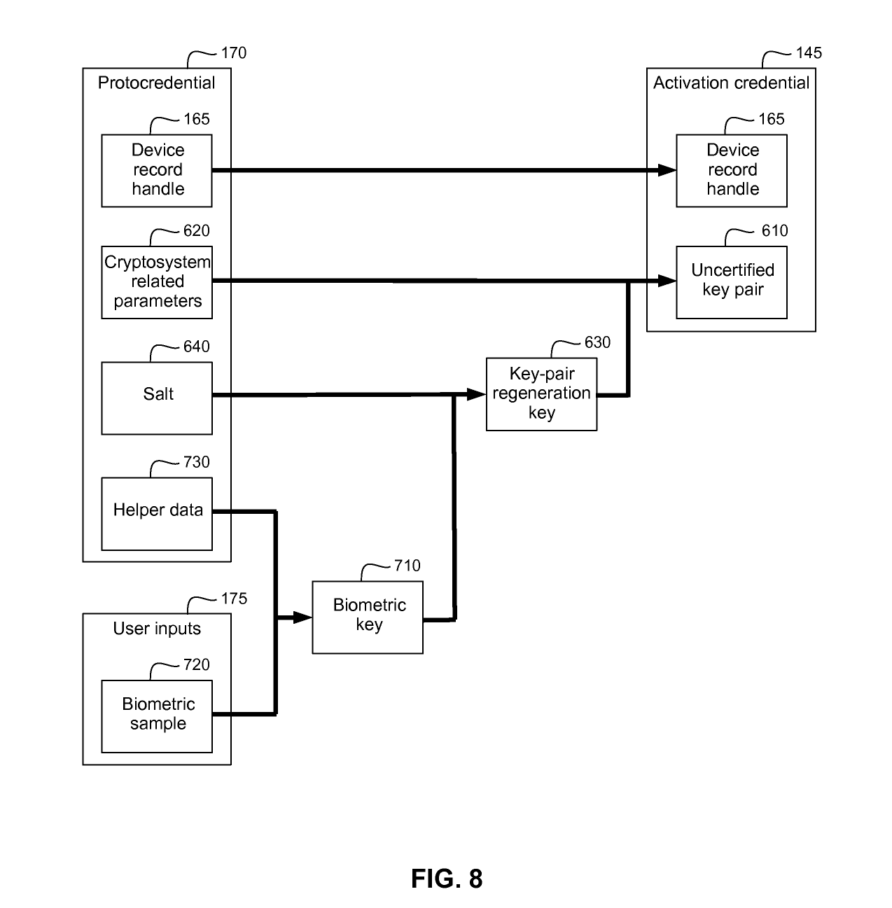

According to embodiments of type IV illustrated in FIG. 8, activation credential 145 comprises device record handle 165 and uncertified key pair 610, which is regenerated from cryptosystem related parameters 620 and key-pair regeneration key 630. Key-pair regeneration key 630 is itself computed using HKDF with a random high-entropy salt 640 as Salt input, biometric key 710 as Input Keying Material, and a value of the byte-length input parameter L that causes the output to be a string of bitlength suitable for the cryptosystem of key pair 610. Biometric key 710 is regenerated from biometric sample 720 and helper data 730. Device record handle 165, cryptosystem related parameters 620, salt 640 and helper data 730 are protocredential parameters, while biometric sample 720 is a user input.

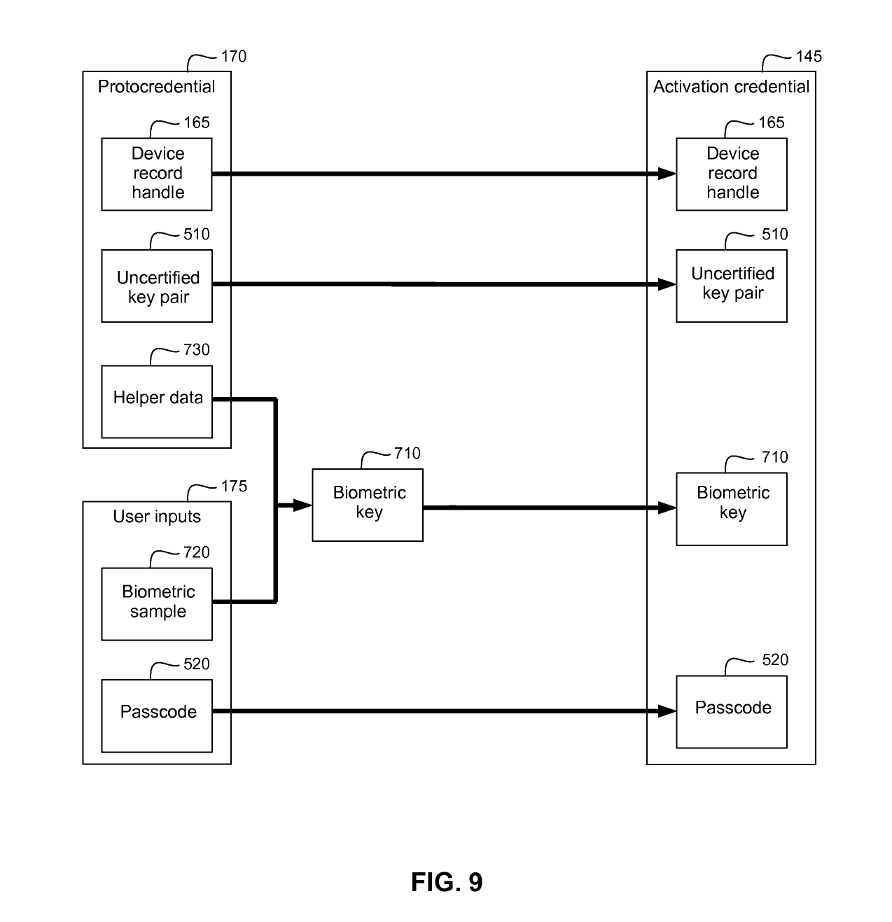

According to some embodiments of type V illustrated in FIG. 9, activation credential 145 comprises device record handle 165, uncertified key pair 510, passcode 520, and biometric key 710, which is regenerated from biometric sample 720 and helper data 730. Device record handle 165, key pair 510 and helper data 730 are protocredential related parameters, while passcode 520 and biometric sample 720 are user inputs.

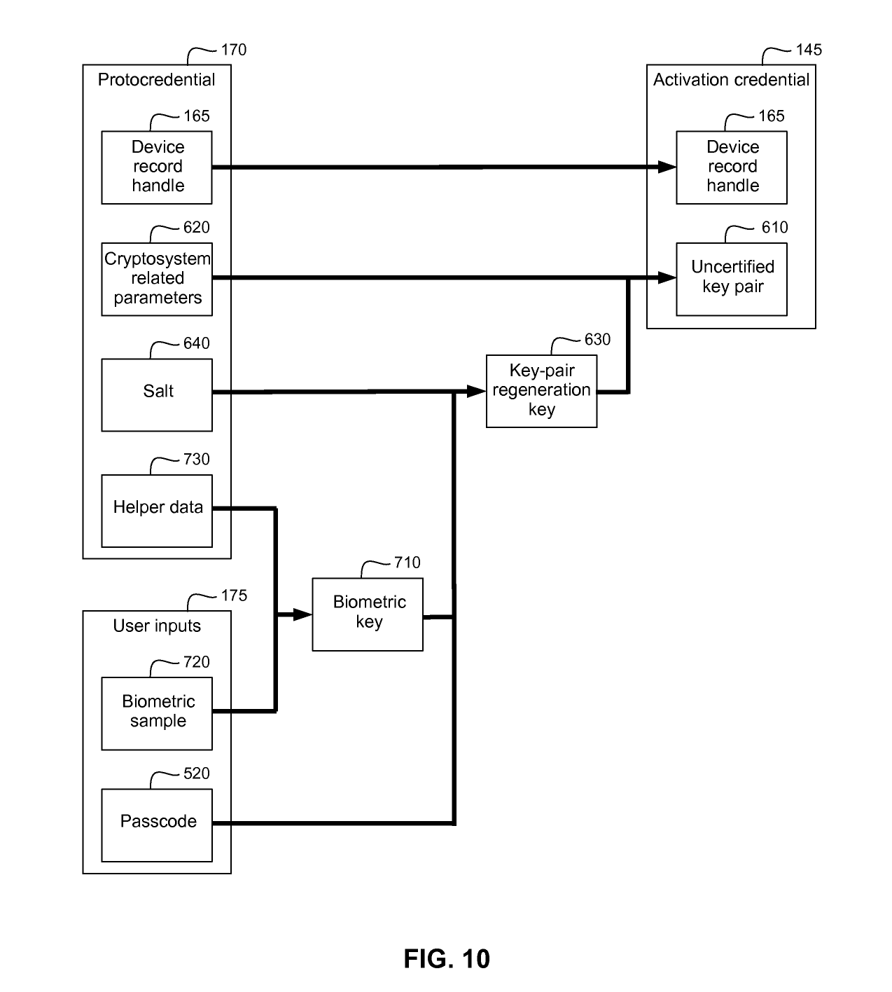

According to some embodiments of type VI illustrated in FIG. 10, activation credential 145 comprises device record handle 165 and uncertified key pair 610, which is regenerated from cryptosystem related parameters 620 and key-pair regeneration key 630. Key-pair regeneration key 630 is itself computed using HKDF with a random high-entropy salt 640 as Salt input, passcode 520 and biometric key 710 as Input Keying Material, and a value of the byte-length input parameter L that causes the output to be a string of bitlength suitable for the cryptosystem of key pair 610. Biometric key 710 is regenerated from biometric sample 720 and helper data 730. Device record handle 165, cryptosystem related parameters 620, salt 640 and helper data 730 are protocredential parameters, while passcode 520 and biometric sample 720 are user inputs.

The passcode and/or the biometric key are used differently in embodiments of types I, III and V on one hand, and embodiments of types II, IV and VI on the other hand. In the latter embodiments they are used to regenerate key pair 610. In the former embodiments, on the other hand, they are sent by the credential activation program 125 to key storage service 135 as bearer tokens, in the course of the two-party key retrieval protocol of step 430 of process 400, as further described below. (A bearer token is a secret that is sent by a sender to a receiver and contributes to authenticating the sender to the receiver by the mere fact of being received by the receiver, the sender being herein credential activation program 125, the receiver being herein key storage service 135.)

An important difference that distinguishes the present invention, particularly embodiments of types I, III and V, from the prior art is that, in the present invention, key storage service 135 verifies possession of activation credential 145 by verifying a signature computed with the private key component of key pair 610 and comparing a joint hash of the bearer tokens and the public key component of the key pair to a reference joint hash stored in device record 155, as described in more detail below. Furthermore, the public key is not present in the device record used by the key storage service; instead it is sent by the program to the service at authentication time and is only present while authentication is taking place. Thus an adversary who breaches the security of the key storage service at any other time only finds the reference joint hash. Without a separate hash of the bearer tokens and without the public key, the adversary cannot mount an offline attack against the bearer tokens.

By contrast, in the above mentioned U.S. patent application Ser. No. 14/194,703, an application authenticates to a service with a PIN and a signature computed with the private key of a key pair (cf. paragraphs 82-83). But the public key is not sent to the service at authentication time. Instead it is stored by the server, which uses it to verify the signature and for other purposes. The PIN is verified separately, using a hash of the PIN that is also stored by the server. An adversary who breaches the security of the service can trivially crack the PIN with an offline attack. Then, if the adversary captures the computing device where the application is running, he or she can use the application by entering the PIN through the standard user interface of the application, without having to tamper with the device.

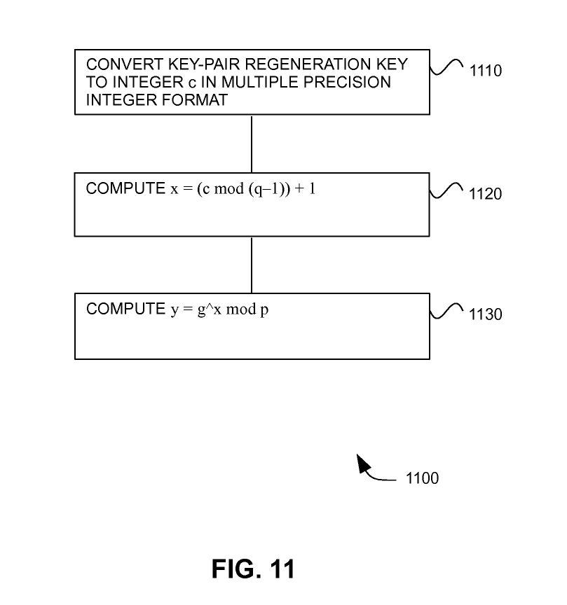

FIG. 11 is a flow diagram of a process 1100 performed by credential actiation program 125 for regenerating key pair 610 according to some embodiments, among the embodiments of types II, IV and VI, wherein key pair 610 is a DSA key pair. Processes for regenerating ECDSA and RSA key pairs are described in cross-referenced patent applications Ser. Nos. 14/016,022 and 13/954,973.

With the notations of the Digital Signature Standard (DSS), published by the National Institute of Standards and Technology (NIST) as FIPS PUB 186-4, a DSA cryptosystem comprises parameters p, q, g, x and y, where p, q and g are domain parameters, x is a private parameter, and y is a public parameter; however, y should be kept secret so that it cannot be used to mount an offline attack by an unauthorized user. A signature is computed using parameters p, q, g and x, and verified using parameters p, q, g and y. In some embodiments the domain parameters p, q and g are configured into credential activation program 125 and key storage service 135, while in other they are specific to the computing device. In the latter embodiments p, q and g are the cryptosystem related parameters 610, the DSA private key used by the credential activation program to compute signatures is (p, q, g, x), and the DSA public key used by the key storage service to verify signature is (p, q, g, y). In the former embodiments the set of cryptosystem related parameters is empty, the DSA private key is x, and the DSA public key is y.

Process 1100 takes as inputs key-pair regeneration key 620 and DSA parameters p, q and g, which in some embodiments are cryptosystem related parameters 610 and in other embodiments are configured into credential activation program 120 as explained above. As mentioned above in connection with FIGS. 6, 8 and 10, key-pair regeneration key 620 has a bitlength suitable to the cryptosystem of key pair 610. In embodiments illustrated by FIG. 11, wherein key pair 610 is a DSA key pair, a suitable length is N+64, which makes it possible to substitute the key-pair regeneration key for the “returned_bits” variable of the process for generating a DSA key pair described in Appendix B.1.1 of the DSS. Process 1100 performs steps 5, and 7 of the process of Appendix B.1.1, with the key-pair regeneration key substituted for the returned_bits variable.

At 1110, program 125 converts the key-pair regeneration key to an integer “c” in a multiple precision integer format. Then process 1100 continues at 1120.

At 1120, the program computes x=(c mod (q−1))+1. Then the process continues at 1130.

At 1130, the program computes y=ĝx mod p, where the symbol “̂” denotes exponentiation. Then the process terminates.

In embodiments where parameters p, q and g are specific to the computing device, the DSA key pair produced by process 1100 is the 5-tuple (p, q, g, x, y). In embodiments where p, q and g are configured into credential activation program 125 and key storage service 135, the DSA key pair produced by process 1100 is the pair (x, y).

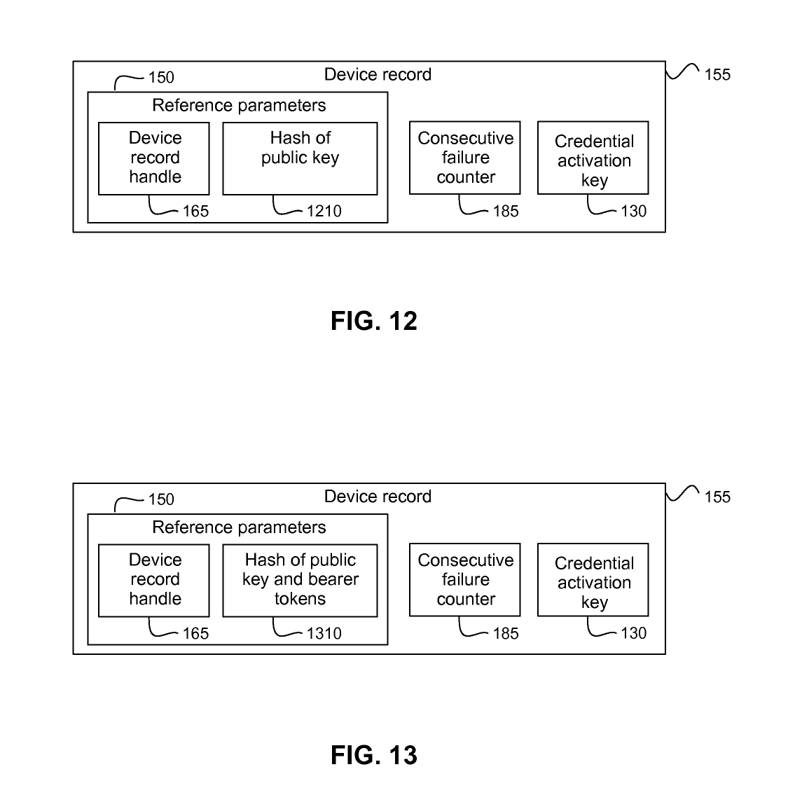

FIGS. 12-16 are block diagrams illustrating device record 155 according to various embodiments in all of which key storage service 135 is configured to be usable with a plurality of computing devices, so that there is a need for a database 160 of device records.

FIG. 12 illustrates device record 155 according to some embodiments of types II, IV and VI. Reference parameters 150 comprise device record handle 165 and a hash 1210 of the public key component of key pair 610. Consecutive failure counter 185 and credential activation key 130 are as described above.

FIG. 13 illustrates device record 155 according to some embodiments of types I, III and V. Reference parameters 150 comprise device record handle 165 and a hash 1310 of the public key component of key pair 610 and one or more received bearer tokens, each of the bearer tokens being either a passcode or a biometric key received by key storage service 135 from credential activation program 125 in the course of the two-party key retrieval protocol of step 430 of process 400. Consecutive failure counter 185 and credential activation key 130 are as described above.

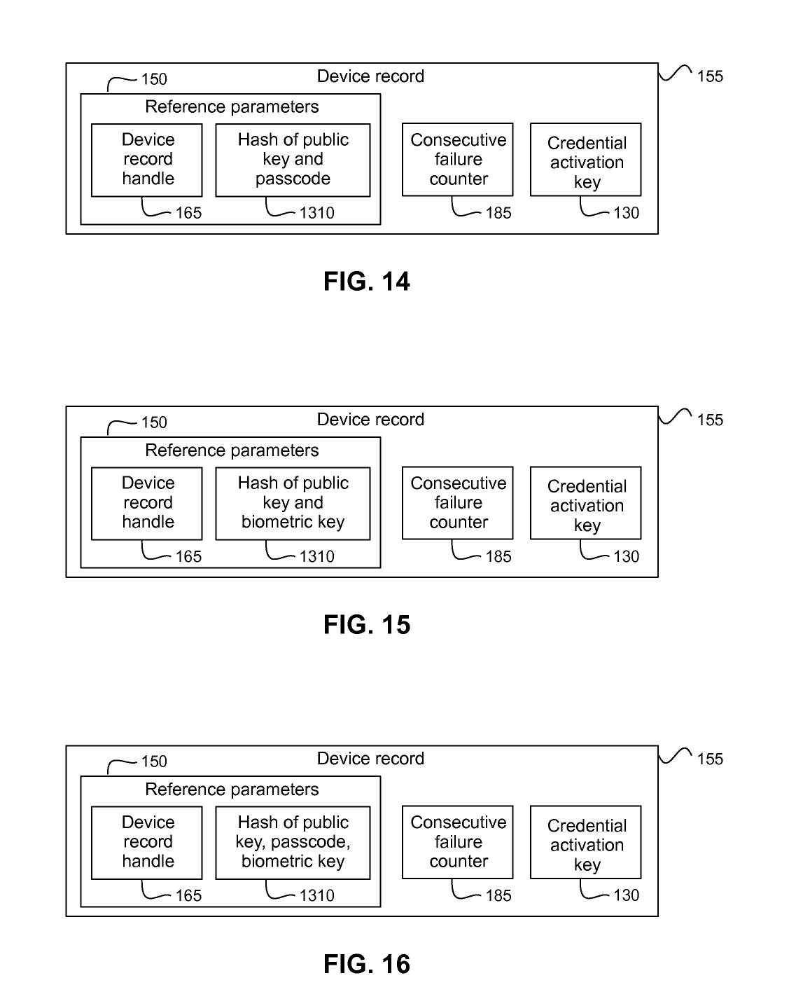

FIG. 14 is a special case of FIG. 13 illustrating device record 155 according to some embodiments of type I. Reference parameters 150 comprise device record handle 165 and a hash 1310 of the public key component of key pair 610 and a passcode. Consecutive failure counter 185 and credential activation key 130 are as described above.

FIG. 15 is a special case of FIG. 13 illustrating device record 155 according to some embodiments of type III. Reference parameters 150 comprise device record handle 165 and a hash 1310 of the public key component of key pair 610 and a biometric key. Consecutive failure counter 185 and credential activation key 130 are as described above.

FIG. 16 is a special case of FIG. 13 illustrating device record 155 according to some embodiments of type V. Reference parameters 150 comprise device record handle 165 and a hash 1310 of the public key component of key pair 610, a passcode and a biometric key. Consecutive failure counter 185 and credential activation key 130 are as described above.

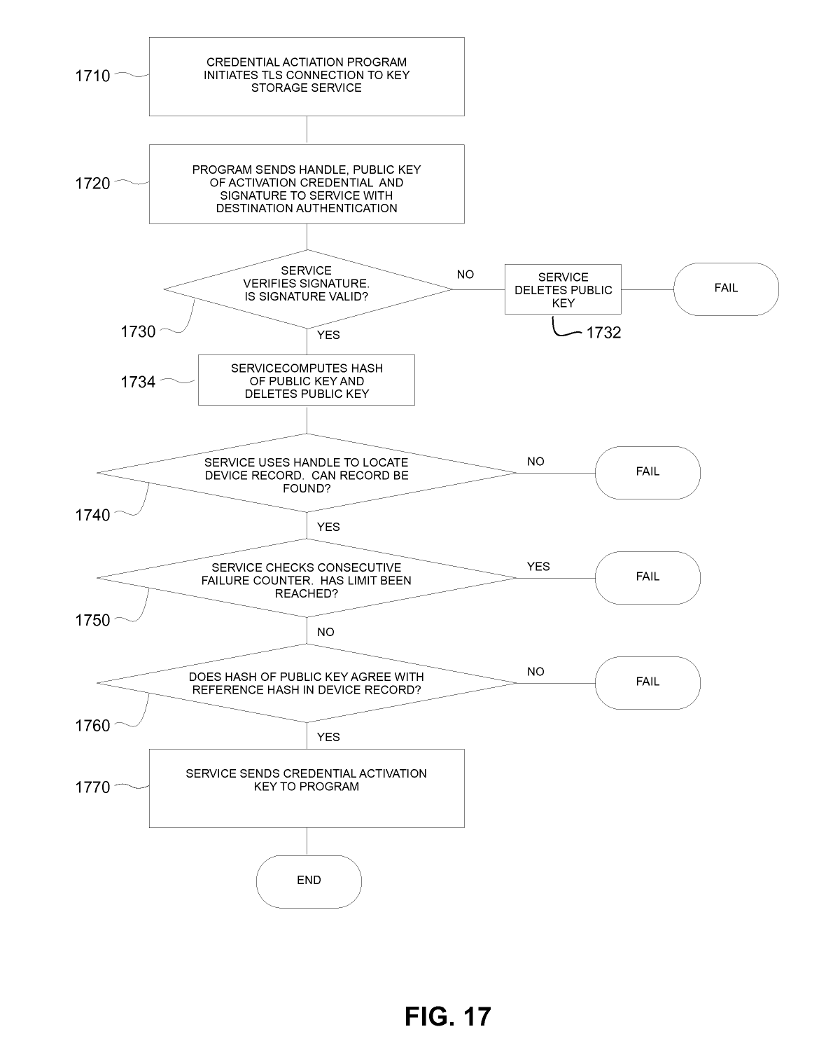

FIGS. 17-20 are flow diagrams of processes that retrieve credential activation key 130 at step 430 of process 400 according to various embodiments. Such processes are two-party protocols performed by credential activation program 125 and key storage service 135.

FIG. 17 is a flow diagram of a process 1700 that retrieves credential activation key 130 according to some embodiments, among the embodiments of types II, IV and VI, wherein credential activation program 125 and key storage service 135 communicate over a secure connection, the secure connection being more specifically a TLS connection.

At 1710 credential activation program 125 initiates a TLS connection to key storage service 135. During the initial handshake of the connection, service 135 authenticates to program 125 by presenting a TLS server certificate and demonstrating knowledge of the corresponding private key. The server certificate is issued by a certificate authority (CA) and backed by a certificate chain that ends with the public key of a root CA known to the program. After the handshake, the program and the service communicate using a ciphersuite that provides confidentiality and data authentication for both directions of traffic. After 1710 the process continues at 1720.

At 1720, program 125 authenticates to service 135 by sending a proof of possession of activation credential 145. As illustrated in FIGS. 6, 8 and 10 for embodiments of types II, IV and VI respectively, activation credential 145 comprises device record handle 165 and key pair 610. The proof of possession comprises device record handle 165, the public key component of key pair 610, and a signature computed with the private key component of key pair 610 on the master key of the TLS connection concatenated with the TLS server certificate. Since service 135 authenticated during the handshake with a TLS server certificate, and the ciphersuite used by the connection provides data authentication, the proof of possession is sent to service 135 with destination authentication. After 1720 the process continues at 1730.

At 1730, service 135 verifies the signature using the public key. If the verification fails, the process continues at 1732. If the verification succeeds, the process continues at 1734.

At 1732 service 135 deletes the public key. Then the process fails.

At 1734 service 135 computes a hash of the public key and deletes the public key. Then the process continues at 1740.

At 1740, service 135 uses the device record handle received at 1720 to locate device record 155. If a device record with the received device record handle cannot be found, the process fails. Otherwise the process continues at 1750.

At 1750, service 135 checks if consecutive failure counter 185 in device record 155 has reached its configured limit. If so, the process fails. Otherwise the process continues at 1760.

At 1760, service 135 checks if the hash of the public key computed at 1734 coincides with hash-of-public-key reference parameter 1210 of FIG. 12. If not, the process fails. Otherwise the process continues at 1770.

At 1770, service 135 sends credential activation key 130 found in device record 155 to program 125. Then the process terminates.

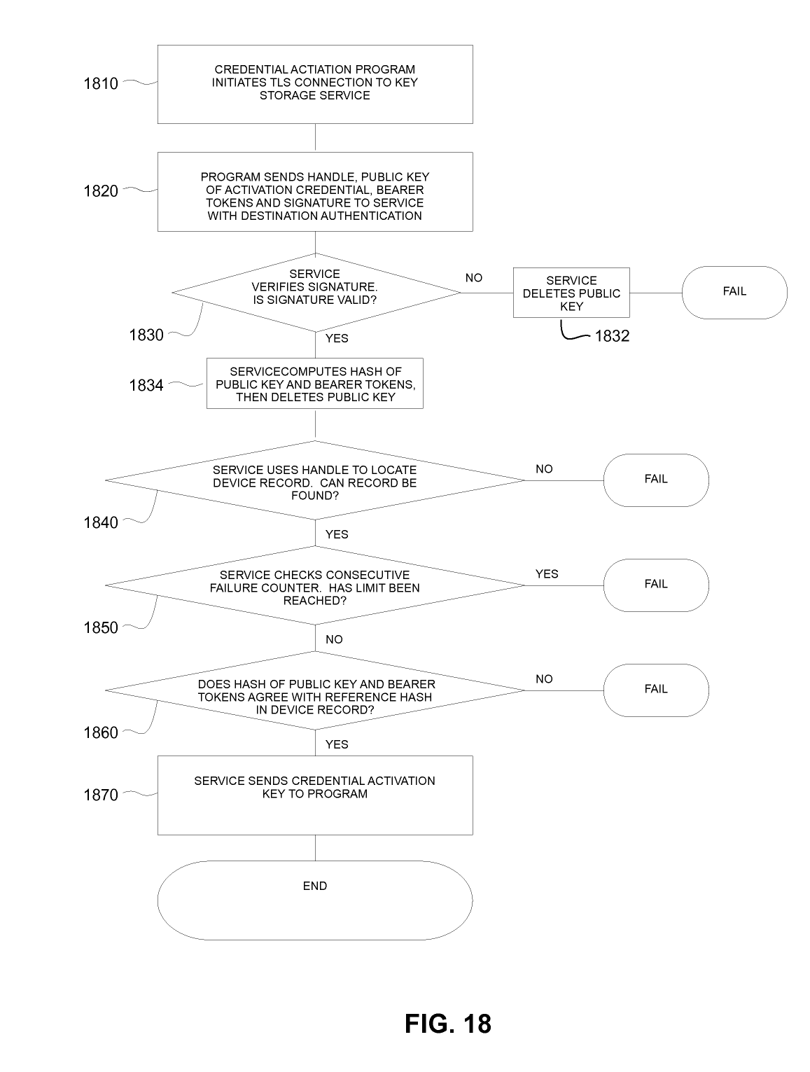

FIG. 18 is a flow diagram of a process 1800, which differs from process 1700 in that it is concerned with embodiments of types I, III, and V instead of embodiments of types II, IV and VI. Specifically, process 1800 retrieves credential activation key 130 according to some embodiments, among the embodiments of types I, III and V, wherein credential activation program 125 and key storage service 135 communicate over a secure TLS connection.

At 1810 credential activation program 125 initiates a TLS connection to key storage service 135 as at step 1710 of process 1700. Then process 1800 continues at 1820.

At 1820, program 125 authenticates to service 135 by sending a proof of possession of activation credential 145. As illustrated in FIGS. 5, 7 and 9 for embodiments of types I, III and V respectively, activation credential 145 comprises device record handle 165, key pair 610 and one or more bearer tokens: passcode 520 according to embodiments of type I, biometric key 710 according to embodiments of type III, both passcode 520 and biometric key 710 according to embodiments of type V. The proof of possession comprises device record handle 165, the public key component of key pair 610, the bearer tokens, and a signature computed with the private key component of key pair 610 on the master key of the TLS connection concatenated with the TLS server certificate. As at step 1720 of process 1700 and for the same reasons, the proof of possession is sent to service 135 with destination authentication. After 1820 the process continues at 1830.

At 1830, service 135 verifies the signature using the public key. If the verification fails, the process continues at 1832. If the verification succeeds, the process continues at 1834.

At 1832 service 135 deletes the public key. Then the process fails.

At 1834 service 135 computes a hash of the public key and the bearer tokens, then deletes the public key. Then the process continues at 1840.

At 1840, service 135 uses the device record handle received at 1720 to locate device record 155. If a device record with the received device record handle cannot be found, the process fails. Otherwise the process continues at 1750.

At 1850, service 135 checks if consecutive failure counter 185 in device record 155 has reached its configured limit. If so, the process fails. Otherwise the process continues at 1860.

At 1860, service 135 checks if the hash of the public key and the bearer tokens computed at 1834 coincides with hash-of-public-key-and-bearer-tokens reference parameter 1310 of FIG. 13. If not, the process fails. Otherwise the process continues at 1870.

At 1870, as at 1770 of step 17, service 135 sends credential activation key 130 found in device record 155 to program 125. Then the process terminates.

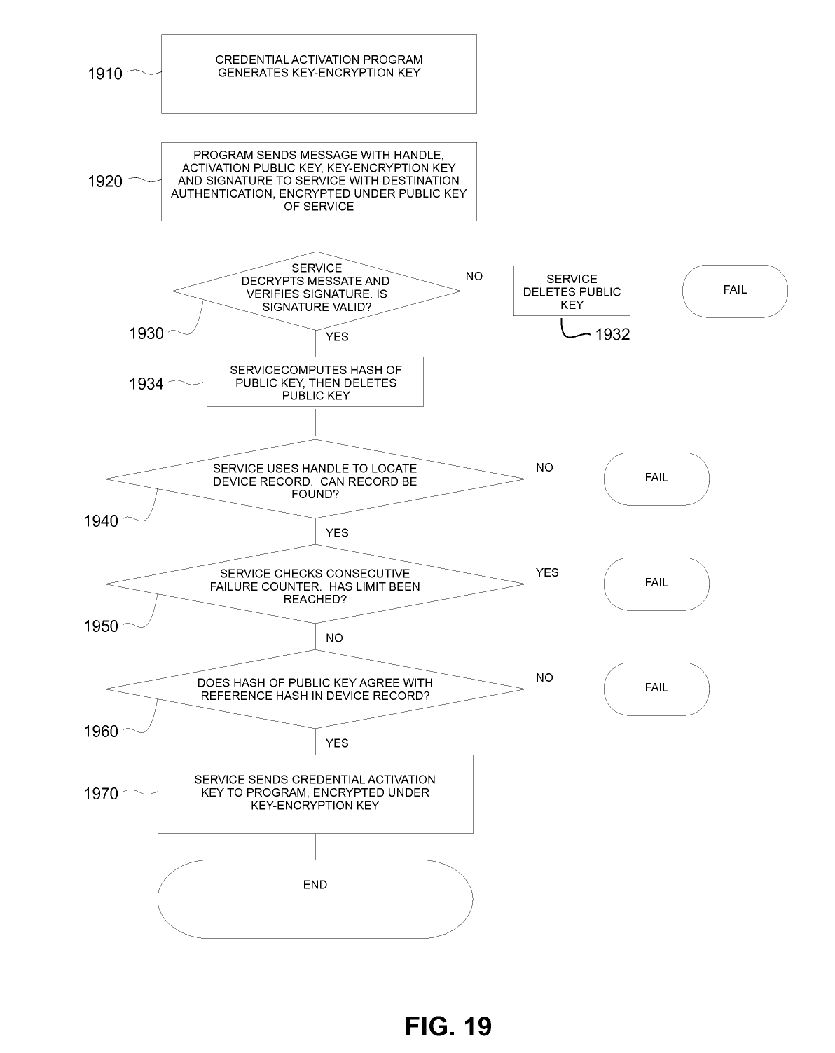

FIG. 19 is a flow diagram of a process 1900 that retrieves credential activation key 130 according to some embodiments, among the embodiments of types II, IV and VI, wherein credential activation program 125 and key storage service 135 do not make use of a secure connection.

At 1910 credential activation program 125 generates a random AES key (the “key-encryption key”) that service 135 will use to encrypt the credential activation key 130 before sending it to program 125. Then the process continues at 1920.

At 1920 program 125 sends service 135 a message comprising the key-encryption key that proves possession of activation activation credential 145. As illustrated in FIGS. 6, 8 and 10 for embodiments of types II, IV and VI respectively, credential 145 comprises device record handle 165 and key pair 610. The message comprises device record handle 165, the public key component of key pair 610, the key-encryption key, and a signature computed with the private key component of key pair 610 on the device record handle, the public key and the key-encryption key; in embodiments where key pair 610 pertains to one of the cryptosystems DSA, ECDSA or RSA, the signature is computed as specified by the DSS. The message is encrypted with a random message-encryption key, using AES in a mode of operation such as CFB or OFB with a random initialization vector, and the ciphertext and initialization vector are sent to service 135, along with a ciphertext obtained by encrypting the message-encryption key and the initialization vector using a public key encryption cryptosystem such as RSA with a public key of service 135 configured into program 125. (RSA can be used both for digital signature and encryption.) Since the message is encrypted under the message-encryption key, which is itself encrypted under a public key of service 135, the message is sent to the service with destination authentication. Then the process continues at 1930.

At 1930, service 135 decrypts the message-encryption key and initialization vector, uses them to decrypt the signed message, and verifies the signature using the public key found in the message. If the verification fails, the process continues at 1932. If the verification succeeds, the process continues at 1934.

At 1932 service 135 deletes the public key. Then the process fails.

At 1934 service 135 computes a hash of the public key and deletes the public key. Then the process continues at 1940.

At 1940, service 135 uses the device record handle found in the message to locate device record 155. If a device record with the received device record handle cannot be found, the process fails. Otherwise the process continues at 1950.

At 1950, service 135 checks if consecutive failure counter 185 in device record 155 has reached its configured limit. If so, the process fails. Otherwise the process continues at 1960.

At 1960, service 135 checks if the hash of the public key found in the message coincides with hash-of-public-key reference parameter 1210 of FIG. 12. If not, the process fails. Otherwise the process continues at 1970.

At 1970, service 135 sends credential activation key 130 found in device record 155 to program 125, encrypted using AES with the key-encryption key found in the message. (If the credential activation key is not 128-bit long, AES is used in a mode such as OFB or CFB with a random initialization vector, and the initialization vector is sent along with the ciphertext.) Then the process terminates.

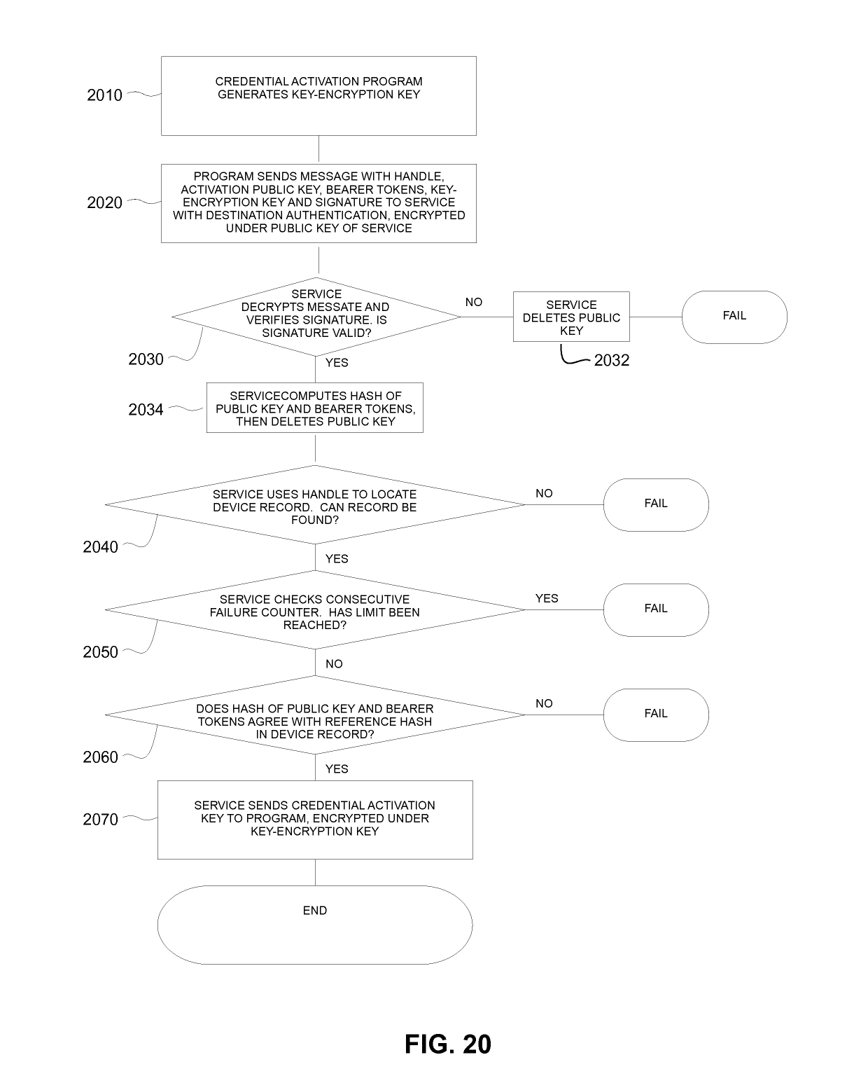

FIG. 20 is a flow diagram of a process 2000, which differs from process 1900 in that it is concerned with embodiments of types I, III, and V instead of embodiments of types II, IV and VI. Specifically, process 2000 retrieves credential activation key 130 according to some embodiments, among the embodiments of types I, III and V, wherein credential activation program 125 and key storage service 135 do not make use of a secure connection.

At 2010 credential activation program 125 generates a random AES key (the “key-encryption key”) that service 135 will use to encrypt the credential encryption key before sending it to program 125. Then the process continues at 2020.

At 2020 program 125 sends service 135 a message that proves possession of activation credential 145. As illustrated in FIGS. 5, 7 and 9 for embodiments of types I, III and V respectively, credential 145 comprises device record handle 165, key pair 610 and one or more bearer tokens: passcode 520 according to embodiments of type I, biometric key 710 according to embodiments of type III, both passcode 520 and biometric key 710 according to embodiments of type V. The message comprises device record handle 165, the public key component of key pair 610, the bearer tokens, the key-encryption key, and a signature computed with the private key component of key pair 610 on the device record handle, the public key, the bearer tokens and the key-encryption key; in embodiments where key pair 610 pertains to one of the cryptosystems DSA, ECDSA or RSA, the signature is computed as specified by the DSS. The message is encrypted with a random message-encryption key, using AES in a mode of operation such as CFB or OFB with a random initialization vector, and the ciphertext and initialization vector are sent to service 135, along with a ciphertext obtained by encrypting the message-encryption key and the initialization vector using a public key encryption cryptosystem such as RSA with a public key of service 135 configured into program 125. Since the message is encrypted under the message-encryption key, which is itself encrypted under a public key of service 135, the message is sent to the service with destination authentication. Then the process continues at 2030.

At 2030, service 135 decrypts the message-encryption key and initialization vector, uses them to decrypt the signed message, and verifies the signature using the public key found in the message. If the verification fails, the process continues at 2032. If the verification succeeds, the process continues at 2034.

At 2032 service 135 deletes the public key. Then the process fails.

At 2034 service 135 computes a hash of the public key and the bearer tokens, and deletes the public key. Then the process continues at 2040.

At 2040, service 135 uses the device record handle found in the message to locate device record 155. If a device record with the received device record handle cannot be found, the process fails. Otherwise the process continues at 2050.

At 2050, service 135 checks if consecutive failure counter 185 in device record 155 has reached its configured limit. If so, the process fails. Otherwise the process continues at 2060.

At 2060, service 135 computes a hash of the public key and the bearer tokens found in the message and checks if it coincides with hash-of-public-key-and-bearer-tokens reference parameter 1310 of FIG. 13. If not, the process fails. Otherwise the process continues at 2070.

At 2070, as at 1870 of step 18, service 135 sends credential activation key 130 found in device record 155 to program 125, encrypted using AES with the key-encryption key found in the message. (If the credential activation key is not 128-bit long, AES is used in a mode such as OFB or CFB with a random initialization vector, and the initialization vector is sent along with the ciphertext.) Then the process terminates.

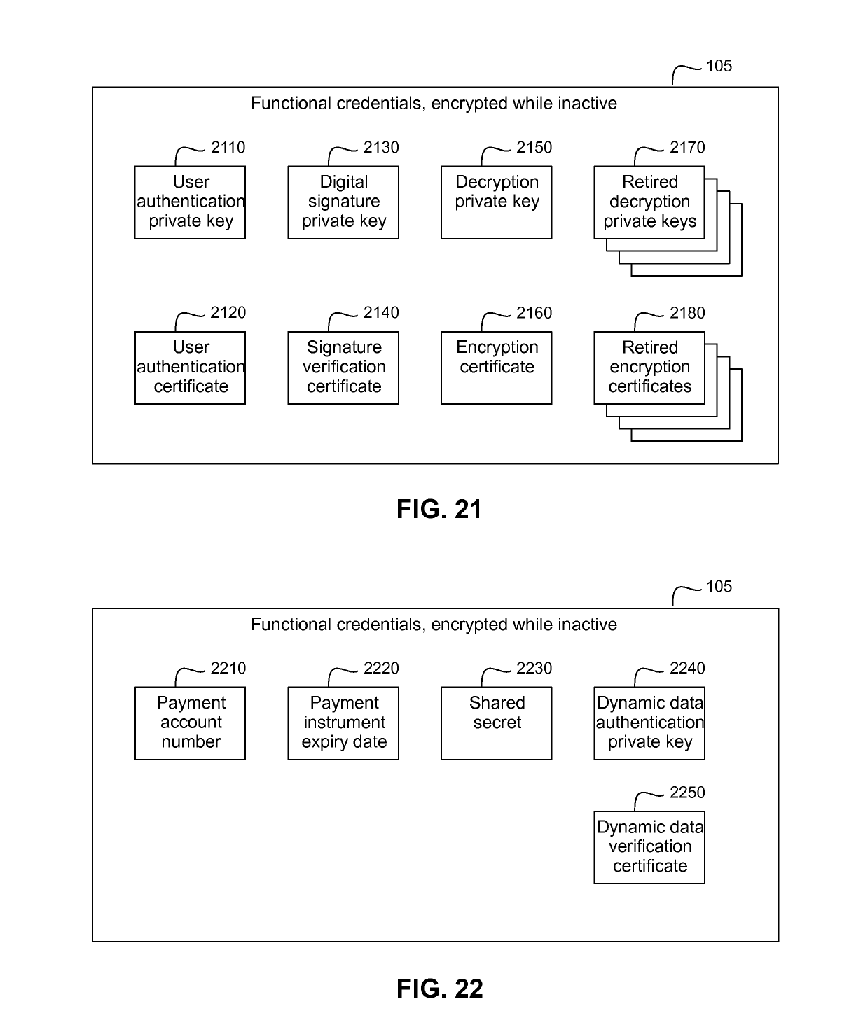

FIG. 21 is a block diagram illustrating functional credentials 105 similar to some of the credentials carried in a Personal Identity Verification (PIV) card, stored in storage 120, and encrypted while inactive under keys derived from credential activation key 130. The credentials carried in a PIV card are specified in FIPS PUB 201-2 and related Special Publications. The credentials illustrated in FIG. 21 include:

a user-authentication private key 2110 and its corresponding user-authentication certificate 2120, usable in particular for TLS client authentication;

a digital signature private key 2130 and a corresponding digital signature verification certificate 2140, usable in particular for signing and verifying email messages respectively;

a current decryption private key 2150 and a corresponding encryption certificate 2160, usable in particular for decrypting and encrypting email messages respectively, and preferably retrieved from an escrow server so that the same private key may be present in a plurality of devices controlled by the same user.

some number of retired decryption private keys 2170 and their corresponding encryption certificates 2180.

FIG. 22 is a block diagram illustrating functional credentials 105 similar to some of the credentials carried in a payment smart card, stored in storage 120, and encrypted while inactive under keys derived from credential activation key 130. They include:

A payment account number 2210.

A payment instrument expiration date 2220.

A shared secret 2230 used to derive symmetric keys for signing payment transaction cryptograms; in some embodiments the payment account number is a primary account number and the secret is shared with a payment instrument issuing bank, which verifies the cryptograms; in other embodiments the payment account number is a payment token used instead of the primary account number for increased security, and the cryptograms are verified by a token service provider.

A private key 2240 used to authenticate dynamic payment data by signing the data and a corresponding dynamic data verification certificate 2250; a signature on dynamic payment data is verified by a merchant's point of sale terminal or web site.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein.

What is claimed is:

1. A method of activating credentials stored in a computing device, the credentials being encrypted while inactive, the device containing an uncertified key pair comprising a private key and a public key, the method comprising:
the device obtaining one or more user inputs from a user;
the device deriving one or more bearer tokens from the user inputs;
the device sending the bearer tokens, the public key and a signature computed with the private key to a key storage service with destination authentication;
the service verifying the signature;
the service computing a hash of the bearer tokens and the public key and verifying that the computed hash is the same as a reference hash available to the verifier;
the service sending a credential activation key to the device;
the device deriving one or more decryption keys from the credential activation key; and
the device decrypting the credentials with the decryption keys.
